(19) United States
(12) Patent Application Publication
(10) Pub. No.: US 2022/0334254 A1
(43) Pub. Date: Oct. 20, 2022

(54) DISTANCE MEASUREMENT DEVICE

(71) Applicant: Nippon Telegraph and Telephone Corporation, Tokyo (JP)

(72) Inventors: Masahiro Ueno, Tokyo (JP); Yuichi Akage, Tokyo (JP); Soichi Oka, Tokyo (JP)

(21) Appl. No.: 17/761,952

(22) PCT Filed: Sep. 24, 2019
(86) PCT No.: PCT/JP2019/037243

§ 371 Date: Mar. 18, 2022

(51) Int. Cl. G01S 17/32

(52) U.S. Cl. CPC G01S 17/32

(57) ABSTRACT

A distance measurement apparatus includes an interferometer that detects interference light obtained through interference between continuous light with a temporally swept wavelength, which is output from a wavelength swept light source, and reflected light obtained by reflecting the light by a distance measurement target, and converts the interference light into an interference electrical signal, a spectrum calculation unit that applies discrete Fourier transform to a digital interference signal obtained by the interference electrical signal being AD-converted and calculates a spectrum of a discrete frequency component with an intensity of every frequency of the interference signal as a real number, an interpolation unit that interpolates a spectrum between frequencies of the spectrum, a search unit that acquires a frequency of a peak included in the interpolated spectrum, and a distance calculation unit that calculates a distance to a distance measurement target, based on the frequency.

This patent application is a national phase filing under section 371 of PCT application no. PCT/JP2019/037243, filed on Sep. 24, 2019, which is incorporated herein by reference in its entirety.

### TECHNICAL FIELD

The present disclosure relates to a distance measurement apparatus and relates particularly to a distance measurement technique employing a frequency modulated continuous wave (FMCW) radar method.

### BACKGROUND

An apparatus has been known in the art which measures a film thickness by using a swept source optical coherence tomography (SS-OCT) method having the same principle as the frequency modulated continuous wave (FMCW) radar method for measuring a distance using a frequency-modulated continuous wave (see NPL 1). In the SS-OCT method, a depth of a sample such as a film thickness is measured by applying Fourier transform to detected light obtained by using a wavelength swept light source.

For example, in a known measurement apparatus described in NPL 1, a film is viewed as a Fabry-Perot interferometer, and a light beam of a wavelength swept light source is incident from one side of the film. Furthermore, Fresnel reflected light from the opposite side of the film and Fresnel reflected light from the incident surface are multiplexed at the incident surface for interference. Moreover, the interference light is photoelectrically converted by a photodetector, and an electrical signal (hereinafter, may be referred to as “interference signal”) obtained by photoelectrically converting the interference light is subjected to frequency analysis to obtain a film thickness.

The principle of a known film thickness measurement will now be described. Here, ν(t) (t is a time period) represents a temporal change of a frequency of light emitted from a wavelength swept light source, Δt represents a time period to reciprocate in a film, and n represents a refractive index of the film. At a certain time tₐ, ν(tₐ) is a frequency of light reflected at an incident surface of the film, and ν(tₐ−Δt) is a frequency of light returning back to the incident surface of the film after reciprocating in the film, and as a result, a beat frequency ν_{B}(tₐ) of an interference signal obtained by photoelectrically converting multiplexed light (interference light) is expressed by the following Equation (1):

Equation (1)

ν_{B}(tₐ)=ν(tₐ)−ν(tₐ−Δt) (1)

When z represents a film thickness and c represents a light velocity, Δt=n·2z/c, and therefore, Equation (1) is as follows:

$$\begin{matrix}Equation ( 2 ) & \\ {v}_{B} ( {t}_{a} ) = ν ( {t}_{a} ) - ν ( {t}_{a} - \frac{n \cdot 2 z}{\overline{c}} ) & ( 2 )\end{matrix}$$

When the above Equation (2) is solved for the film thickness z, the film thickness z is expressed by the following Equation (3):

$$\begin{matrix}Equation ( 3 ) & \\ z = \frac{c}{2 n} [ {t}_{a} - {ν}^{- 1} ( ν ( {t}_{a} ) - {ν}_{B} ( {t}_{a} ) ) ] & ( 3 )\end{matrix}$$

where ν⁻¹(.) is an inverse function of ν(.).

It is assumed that the frequency ν of the output light of the wavelength swept light source changes linearly with respect to the time period t as in Equation (4).

Equation (4)

ν(t)=ν′·t+ν₀ (4)

When the frequency ν is represented by Equation (4) above, the inverse function ν⁻¹(.) of ν(t) will be expressed as in Equation (5) below.

$$\begin{matrix}Equation ( 5 ) & \\ t = {ν}^{- 1} ( ν ( t ) ) = \frac{ν ( t ) - {ν}_{0}}{{ν}^{′}} & ( 5 )\end{matrix}$$

The substitution of Equations (4) and (5) into Equation (3) and the rearrangement of the Equation (3) yields the following Equation (6) expressing the film thickness z:

$$\begin{matrix}Equation ( 6 ) & \\ z = \frac{c}{2 n} \frac{{v}_{b} ( {t}_{a} )}{{ν}^{′}} & ( 6 )\end{matrix}$$

When the frequency ν of the wavelength swept light source changes linearly with respect to the time period t as in Equation (4), the frequency ν_{B}(t) of a beat signal is constant regardless of the time period t, and thus, if the frequency of the beat signal is represented as ν_{B}, from Equation (6), the film thickness z is expressed as in the following Equation (7).

$$\begin{matrix}Equation ( 7 ) & \\ z = \frac{c}{2 n} \frac{{v}_{b}}{{ν}^{′}} & ( 7 )\end{matrix}$$

That is, the calculation according to Equation (7) after the beat frequency ν_{B} of the signal is obtained by photoelectrically converting the multiplexed light yields the film thickness z.

The film thickness is described in NPL 1, and it is possible to measure a distance by using a Michelson interferometer instead of a Fabry-Perot interferometer formed of a film. The Michelson interferometer includes a light splitter and two mirrors. An optical path from the light splitter to each of the mirrors is referred to as an arm, and an arm obtained when a distance measurement target is replaced for a first mirror is named a sample arm and an arm on which a second mirror is placed is named a reference arm, and an optical path length difference between the sample arm and the reference arm is 2z according to Equation (7). As a result, when the beat frequency ν_{B} is obtained by using the Michelson interferometer, it is possible to measure a distance to the distance measurement target. However, in this case, (distance of half the optical path length difference between both arms)=(difference in length between both arms) is to be measured.

NPL 1 describes a feature that the peak frequency of a power spectrum of the interference signal is ν_{B} to obtain the beat frequency ν_{B}. Thus, a function representing a response characteristic including a spatial frequency characteristic of an optical system, such as a power spectrum representing one reflection point, is referred to as “point spread function (PSF)”. Typically, in evaluating the power spectrum by digital processing, analog electrical signals are sampled and discrete Fourier transform (fast Fourier transform) is used. Thus, the resulting power spectrum is discretized in frequency. Thus, if there is a true peak in the power spectrum between discrete values of the frequency, it is not possible to obtain a precise beat frequency ν_{B}.

In order to avoid such problems, NPL 1 describes a method of obtaining a value as close as possible to the true peak value by performing zero padding for adding a zero signal to the interference signal and evaluating the power spectrum from the zero-padded interference signal to narrow a discretized frequency interval. In other words, NPL 1 describes a method of obtaining a value as close as possible to the true peak value by performing the zero padding on the interference signal, that is, by padding (interpolating) data between discrete data of the original PSF to not exceed a range of a frequency of the interference signal.

For example, in a way of indicating the PSF, NPL 2 discloses a technology using the power spectrum in spectral domain OCT (SD-OCT) including SS-OCT, without using a normal spectrum.

Further, after the above Equation (5), the case where the frequency ν of the output light of the wavelength swept light source changes linearly with respect to the time period t as indicated in Equation (4) is described, and if the frequency ν does not change linearly, a method called “rescaling” provided in NPL 3 is used to perform conversion into an interference signal when the frequency ν changes linearly with respect to the time period t by signal processing. In this case, the PSF is calculated from the rescaled interference signal, a frequency at the peak of the PSF is used as the beat frequency ν_{B}, and the film thickness z is obtained by using Equation (7).

### CITATION LIST

### Non Patent Literature

NPL 1: Masatoshi Fujimoto, Mahiro Yamada, Koei Yamamoto, Yuzo Sasaki, Seiji Toyoda, Takashi Sakamoto, Joji Yamaguchi, Tadashi Sakamoto, Masahiro Ueno, Tadayuki Imai, Eiichi Sugai, Shogo Yagi, “Stable wavelength-swept light source designed for industrial applications using KTN beam scanning technology”, Proc. of SPIE, Vol. 10110, pp. 101100Q-1-12, 2017.
NPL 2: Anant Agrawal, T. Joshua Pfefer, Peter D. Woolliams, Peter H. Tomlins, and George Nehmetallah, “Methods to assess sensitivity of optical coherence tomography systems”, Biomed Opt Express, Vol. 8, No. 2, pp. 902-917, 2017.
NPL 3: Yoshiaki Yasuno, Violeta Dimitrova Madjarova, Shuichi Makita, Masahiro Akiba, Atsushi Morosawa, Changho Chong, Toru Sakai, Kin-Pui Chan, Masahide Itoh, and Toyohiko Yatagai, “Three-dimensional and high-speed swept-source optical coherence tomography for in vivo investigation of human anterior eye segments”, OPTICS EXPRESS, Vol. 13, No. 26, pp. 10652-10664, 2005.

### SUMMARY

### Technical Problem

However, in the known distance measurement technique, the PSF is calculated as the power spectrum of the interference signal, and thus, noise is emphasized more than the normal spectrum, and the peak position of the PSF obtained through interpolation by zero padding and the like is easily influenced by the noise. This results in a problem in that the accuracy of measuring the distance measurement position calculated from the frequency at the peak position (beat frequency νB) deteriorates.

Embodiments of the present disclosure can solve the above-mentioned problems, and an embodiment of the present disclosure provides a distance measurement apparatus not being easily affected by noise and having an excellent measurement accuracy.

### Means for Solving the Problem

In order to solve the problems described above, a distance measurement apparatus according to embodiments of the present disclosure includes a first interferometer that detects first light obtained through interference between continuous light with a temporally swept wavelength, which is output from a light source, and reflected light obtained by reflecting the continuous light by a distance measurement target, and converts the first light into a first interference electrical signal, a first spectrum calculation unit that applies discrete Fourier transform to a digital first interference signal obtained by the first interference electrical signal being AD-converted and calculates a first spectrum of a discrete frequency component with an intensity of every frequency of the first interference signal as a real number, a first interpolation unit that interpolates a spectrum between frequencies of the first spectrum, a first acquisition unit that acquires a first frequency of a peak included in the first spectrum interpolated, and a distance calculation unit that calculates, based on the first frequency, a distance to the distance measurement target.

### Effects of Embodiments of the Invention

According to embodiments of the present disclosure, a first interference signal is applied to discrete Fourier transform, a first spectrum of a discrete frequency component with an intensity of each frequency of the first interference signal as a real number is calculated, and a spectrum between frequencies of the calculated first spectrum is interpolated, and as a result, it is possible to implement a distance measurement apparatus not being easily affected by noise and having an excellent measurement accuracy.

### BRIEF DESCRIPTION OF THE DRAWINGS

FIG. 1 is a block diagram illustrating a configuration of a distance measurement apparatus according to an embodiment of the present disclosure.

FIG. 2 is a block diagram illustrating a configuration of a time data generation unit according to the present embodiment.

FIG. 3 is a block diagram illustrating a configuration of a curve calculation unit according to the present embodiment.

FIG. 4 is a graph showing an operation of a curve calculation unit according to the present embodiment.

FIG. 5 is a graph showing an operation of a resampling unit according to the present embodiment.

FIG. 6 is a block diagram illustrating a configuration of a peak search unit according to the present embodiment.

FIG. 7 is a block diagram illustrating an example of a configuration of a computer that implements a signal processing apparatus according to the present embodiment.

FIG. 8 is a flowchart explaining an operation of a distance measurement apparatus according to the present embodiment.

FIG. 9 is a flowchart explaining an operation of the time data generation unit according to the present embodiment.

FIG. 10 is a graph showing an effect of the distance measurement apparatus according to the present embodiment.

FIG. 11 is a block diagram illustrating a configuration of a peak search unit according to a first modification of the present embodiment.

### DETAILED DESCRIPTION OF ILLUSTRATIVE EMBODIMENTS

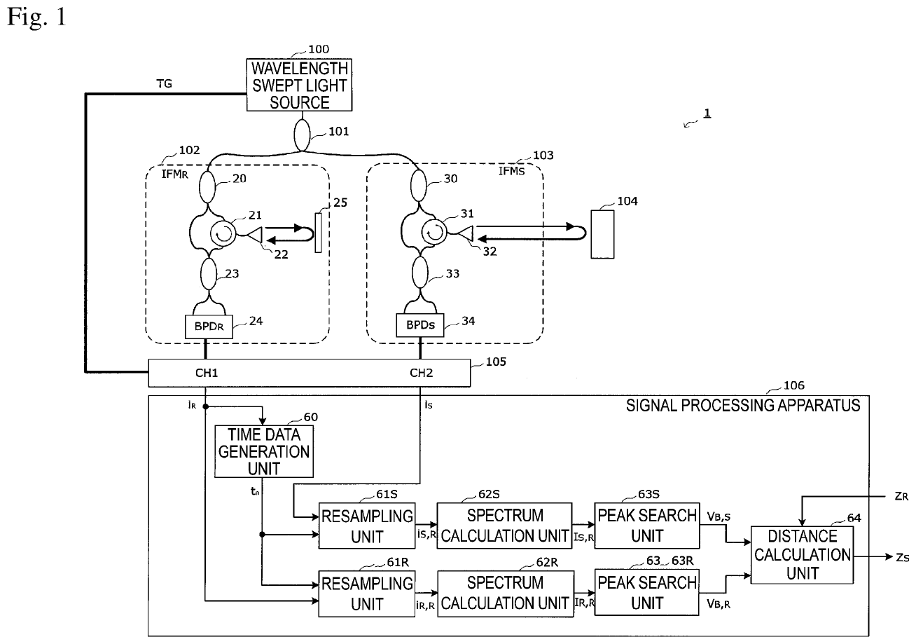

Preferred embodiments of the present disclosure will be described in detail below with reference to FIGS. 1 to 11.

FIG. 1 is a block diagram illustrating a configuration of a distance measurement apparatus 1 according to an embodiment of the present disclosure. The distance measurement apparatus 1 according to the present embodiment measures a distance from a distance measurement interferometer 103 (first interferometer) to a distance measurement target 104 by using a FMCW radar method using a frequency-modulated continuous wave. As illustrated in FIG. 1, the distance measurement apparatus 1 includes a wavelength swept light source 100, interferometers 102 and 103, an analog-to-digital converter (ADC) 105, and a signal processing apparatus 106.

The wavelength swept light source 100 is a light source in which a light frequency continuously changes temporally. A time period-light frequency pattern of light output from the wavelength swept light source 100 is the same for each sweep. Furthermore, the wavelength swept light source 100 outputs a trigger signal TG having a voltage level change synchronized with the sweep. The trigger signal TG is input to the ADC 105 via an electric wire. The light output from the wavelength swept light source 100 is split by a coupler 101 and is input to the interferometer 102 that is a reference interferometer (IFM_{R} indicated by a broken line in FIG. 1), and the distance measurement interferometer 103 (IFM_{S} indicated by a broken line in FIG. 1).

The light output from the wavelength swept light source 100 propagates through an optical fiber and is input to the coupler 101 and the interferometers 102 and 103. More specifically, the coupler 101 divides the light output from the wavelength swept light source 100 into a reference optical path and an object optical path, and the divided light is input to the interferometer 102 corresponding to the reference optical path and the interferometer 103 corresponding to the object optical path, respectively.

As illustrated in FIG. 1, each of the interferometers 102 and 103 further splits the light from the wavelength swept light source 100 into two light beams to measure a phase difference between the two optical paths. In the present embodiment, a configuration is illustrated in which a Mach-Zehnder type interferometer is employed for the interferometers 102 and 103.

The interferometers 102 and 103 include two couplers (couplers 20 and 23 and couplers 30 and 33), circulators 21 and 31, fiber collimators 22 and 32, and balanced detectors (BPD_{R} and BPD_{S}) 24 and 34, respectively.

In the interferometer 102 (second interferometer) provided as a reference interferometer, the light from the wavelength swept light source 100 is further split by the coupler 20, and one light beam is guided through the optical fiber to the coupler 23. The other light beam split by the coupler 20 is incident on the optical fiber proximate to a mirror 25 from the optical fiber via the circulator 21 and output into the space from the fiber collimator 22, and the reflected light reflected by the mirror 25 is again incident on the optical fiber from the fiber collimator 22, and through the optical fiber via the circulator 21, reaches the coupler 23.

An optical path “coupler 20—optical fiber—coupler 23” in the interferometer 102 is referred to as “reference arm”. Furthermore, an optical path “coupler 20—optical fiber—circulator 21—optical fiber—fiber collimator 22—space—mirror 25—space—fiber collimator 22—circulator 21—optical fiber—coupler 23” is referred to as “sample arm”.

In the coupler 23, the light passing through each of the reference arm and the sample arm is multiplexed and output as interference light (second light). The interference light output from the coupler 23 is input to the balanced detector 24.

The balanced detector (BPD_{R}) 24 detects the interference light output from the coupler 23 and converts the detected light into an electrical signal. More particularly, the balanced detector 24 detects a difference in very small signal light generated as a result of interference between the light passing through the sample arm and the light passing through the reference arm, and converts the difference into an electrical signal. The electrical signal converted and output by the balanced detector 24 is referred to as “interference electrical signal” (second interference electrical signal).

In the reference interferometer 102, an optical path length difference between the reference arm and the sample arm is fixed.

Next, the distance measurement interferometer 103 will be described. The interferometer 103 has a configuration obtained by replacing the mirror 25 included in the interferometer 102 with the distance measurement target 104.

In the distance measurement interferometer 103, the reference arm is an optical path passing through the “coupler 30—optical fiber—coupler 33”. The sample arm is an optical path passing through “coupler 30—optical fiber—circulator 31—optical fiber—fiber collimator 32—space—distance measurement target 104—space—fiber collimator 32—circulator 31—optical fiber—coupler 33”.

The balanced detector (BPD_{S}) 34 detects the interference light (first light) output from the coupler 33 and converts the detected light into an interference electrical signal (first interference electrical signal).

The interference electrical signal output from the balanced detector 24 of the interferometer 102 and the interference electrical signal output from the balanced detector 34 of the distance measurement interferometer 103 are respectively input, via the electric wire, to CH1 and CH2 of the ADC 105.

The ADC 105 converts analog interference electrical signals output from the interferometers 102 and 103 into digital signals (hereinafter, referred to as “interference signals”) i_{R} and i_{S}. The ADC 105 fetches interference electrical signals in synchronization with a sweep operation of the wavelength swept light source 100 by the trigger signal TG from the wavelength swept light source 100, and converts the interference electrical signals into discretized interference signals i_{R} and i_{S}.

As illustrated in FIG. 1, the interference electrical signal output from the interferometer 102 input to the CH1 of the ADC 105 is converted into an interference signal (second interference signal) i_{R} from the interferometer 102 that is a reference interferometer, and the interference electrical signal output from the interferometer 103 input to the CH2 is converted into an interference signal (first interference signal) i_{S} from the distance measurement interferometer 103 and the interference signals i_{R} and i_{S} are given, as an input signal, to the signal processing apparatus 106.

Based on the interference signals i_{R} and i_{S}, the signal processing apparatus 106 calculates spectra I_{R, R} (second spectrum) and I_{S, R} (first spectrum) that are discrete frequency components with intensities of each frequency of the interference signals i_{R} and i_{S} as real numbers. The signal processing apparatus 106 interpolates between frequencies of the calculated spectra I_{R, R} and I_{S, R} and acquires the peak frequencies ν_{B, R} (second frequency) and ν_{B, S} (first frequency) included in the spectra I_{R, R} and I_{S, R} to calculate a distance to the distance measurement target 104.

The signal processing apparatus 106 includes a time data generation unit (time generation unit) 60, resampling units 61R and 61S, spectrum calculation units 62R (second spectrum calculation unit) and 62S (first spectrum calculation unit), peak search units 63R and 63S, and a distance calculation unit 64.

The time data generation unit 60 generates, based on the digital interference signal i_{R} input from the CH1 and obtained from the interferometer 102, time data tₙ, which is used in the resampling units 61R and 61S, indicating a timing of resampling of the interference signals i_{R} and i_{S}.

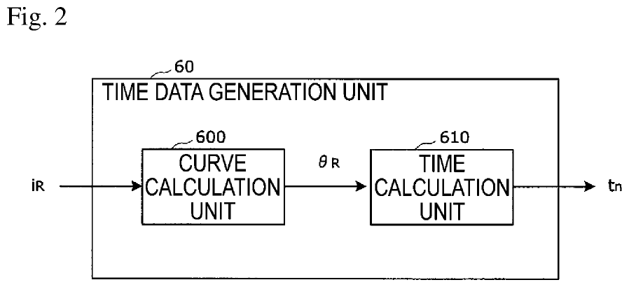

The time data generation unit 60 includes a curve calculation unit 600 and a time calculation unit 610, as illustrated in FIG. 2, for example. The curve calculation unit 600 applies discrete Fourier transform and inverse transform to the interference signal i_{R} from the interferometer 102 that is a reference interferometer to calculate a phase, and further applies phase unwrapping to evaluate an argument θ_{R} as a phase change curve θ_{R}.

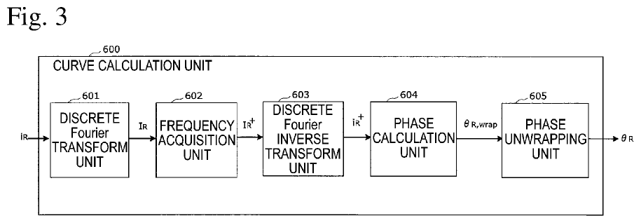

As illustrated in FIG. 3, the curve calculation unit 600 includes a discrete Fourier transform unit 601, a frequency acquisition unit 602, a discrete Fourier inverse transform unit 603, a phase calculation unit 604, and a phase unwrapping unit 605.

The discrete Fourier transform unit 601 applies discrete Fourier transform to the interference signal i_{R} and evaluates a frequency spectrum I_{R} indicating a spatial frequency component. The frequency spectrum I_{R} includes a plurality of peaks including positive and negative frequency components and direct current components.

The frequency acquisition unit 602 acquires a positive frequency component I_{R}⁺ from the frequency spectrum I_{R}. More specifically, the frequency acquisition unit 602 passes only the positive frequency component I_{R}⁺ included in the frequency spectrum I_{R} so that the negative frequency component and the direct current component (frequency is zero) is 0. Furthermore, the frequency acquisition unit 602 can pass only a frequency band originally provided in the interference signal i_{R}, out of positive frequency components by using, for example, a band-pass filter and the like, to remove other frequency components. This reduces noise included in the interference signal i_{R}.

The discrete Fourier inverse transform unit 603 applies discrete Fourier inverse transform to a frequency spectrum including the positive frequency component I_{R}⁺ to restore the interference signal i_{R}⁺ in a spatial region. The interference signal i_{R}⁺ output from the discrete Fourier inverse transform unit 603 is a signal obtained by removing the direct current component and the negative frequency component from the original interference signal i_{R}. Note that the discrete Fourier transform unit 601 and the discrete Fourier inverse transform unit 603 have a configuration corresponding to each other.

The phase calculation unit 604 calculates a phase θ_{R, wrap} of the interference signal i_{R}⁺ restored by the discrete Fourier inverse transform unit 603. More specifically, the phase calculation unit 604 calculates, based on a real part and an imaginary part of the interference signal expressed by a complex number and restored by the discrete Fourier inverse transform unit 603, an argument arg (i_{R}⁺), and outputs a phase θ_{R, wrap} as the calculation result.

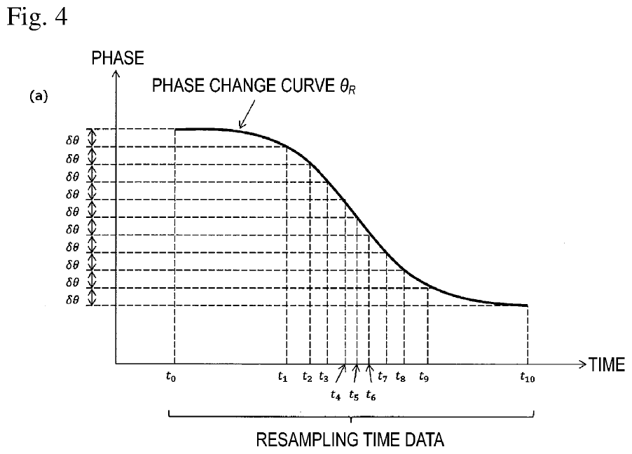

The phase unwrapping unit 605 applies unwrapping to the phase θ_{R, wrap} calculated by the phase calculation unit 604 to evaluate the phase θ_{R} of the interference signal i_{R}⁺ in an unwrapped phase distribution. The argument arg (i_{R}⁺) calculated by the phase calculation unit 604 has a range width of 2π. For example, the argument arg (i_{R}⁺) is in the range of −π to +π or 0 to 2π, and has a phase jump of 2π in a value of the phase θ_{R, wrap} (referred to as “wrapping” state). The phase unwrapping unit 605 can apply unwrapping to the phases by adding and subtracting an integer multiple of 2π to and from the value of the phase θ_{R, wrap} in the wrapping state, for example. The phase θ_{R} output from the phase unwrapping unit 605 is referred to as “phase change curve θ_{R}”. The phase change curve θ_{R} is, for example, a curve as shown in FIG. 4.

The time calculation unit 610 divides the phase change curve θ_{R} to obtain evenly divided phases 60 and calculates, as resampling time data tₙ, a time tₙ corresponding to each of the evenly divided phases 60. For example, as shown in FIG. 4, times t₀ to t₁₀ dividing the phase change curve θ_{R} into each phase value 60 are the resampling time data tₙ. The resampling time data tₙ calculated by the time calculation unit 610 is input to the resampling units 61R and 61S.

The resampling units 61R and 61S each use the resampling time data tₙ to sample the interference signals i_{R} and i_{S} obtained by the interferometers 102 and 103 and output the sampled interference signals i_{R, R} and i_{S, R}.

The resampling units 61R and 61S again sample the interference signals i_{R} and i_{S} sampled by the ADC 105, and thus, the sampling performed by the resampling units 61R and 61S is called “resampling”.

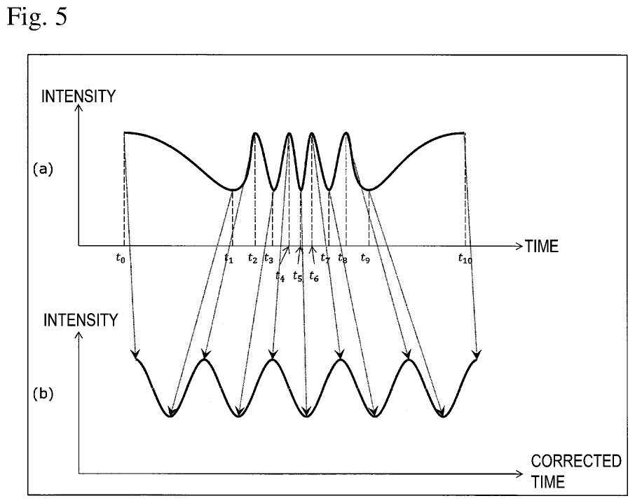

FIG. 5 shows signal waveforms obtained before and after the interference signals i_{R} and i_{S} are resampled by the resampling units 61R and 61S. Graph (a) of FIG. 5 shows an example of the interference signals i_{R} and i_{S} yet to be resampled. Graph (b) of FIG. 5 shows an example of the resampled interference signals i_{R, R} and i_{S, R}.

If the frequency ν of the output light of the wavelength swept light source 100 does not change linearly with respect to the time period t, in the interference signals i_{R} and i_{S}, as shown in graph (a), the frequency ν_{B} (t) changes with respect to the time period t. It is difficult to obtain the frequency ν_{B} corresponding to a distance z even if the interference signals i_{R} and i_{S} in such a state are simply applied to Fourier transform and the resulting peak of the PSF is detected. As a result, if the interference signals i_{R} and i_{S} are resampled at the time tₙ providing equal phase intervals, and intensities of the resampled interference signals i_{R, R} and i_{S, R} are rearranged at equal intervals, then as shown in graph (b), the frequency ν_{B} (t) having an equal waveform, for example, a sine wave, is obtained at any time.

The example of FIG. 5 shows the waveforms of the interference signals i_{R, R} and i_{S, R} obtained when the resampling is performed with the pieces of resampling time data t₀ to t₁₀ having the phase interval of a [rad]. An operation of changing the scale of the time t as in this case is referred to as “rescaling”.

The spectrum calculation units 62R and 62S apply discrete Fourier transform to the resampled interference signals i_{R, R} and i_{S, R} to calculate and output the spectra I_{R, R} and I_{S, R} that are intensity (real number) data for each frequency. Here, the calculation of the spectra I_{R, R} and I_{S, R} with the intensity for each frequency as a “real number” means that the output of the discrete Fourier transform is usually a complex number, and thus, a square root of a sum of a square of an imaginary part and a square of a real part, that is, the intensity, are output.

The distance measurement apparatus 1 according to the present embodiment has one reflection point from the distance measurement target 104. As a result, the spectra I_{R, R} and I_{S, R} are signals corresponding to one point, and thus, indicates a point spread function (PSF) representing an input and output characteristic of an optical system. For example, NPL 2 discloses a known example in which instead of the spectrum, a power spectrum that is a square of the intensity is used as the PSF. However, in the present embodiment, rather than the power spectrum, the spectra I_{R, R} and I_{S, R} in which the intensity for each frequency is a real number are calculated.

Note that the spectrum calculation units 62R and 62S may perform a preprocessing step by applying a window function before applying discrete Fourier transform to the interference signals i_{R, R} and i_{S, R} resampled in the resampling units 61R and 61S. Examples of the window function include a Hanning window, a Hamming window, a Blackman window, and a Gaussian window. In particular, a window having zero of both ends of the window function is more useful because a false noise referred to as a spurious noise occurring from discontinuities in signals is less likely to occur.

The peak search units 63R and 63S detect and output frequencies ν_{B, R} and ν_{B, S} corresponding to peaks of spectra I_{R, R} and I_{S, R} calculated by the spectrum calculation units 62R and 62S. These frequencies ν_{B, R} and ν_{B, S} are the beat frequencies caused by an optical path length difference between the reference arm and the sample arm of the interferometers 102 and 103. In the present embodiment, the spectrum calculation units 62R and 62S perform the discrete Fourier transform to evaluate the spectra I_{R, R} and I_{S, R}. Thus, if the spectra I_{R, R} and I_{S, R} are discrete and there is a true peak in the spectrum between the discrete values of the frequencies ν_{B, R} and ν_{B, S}, it is not possible to obtain the exact beat frequency ν_{B}.

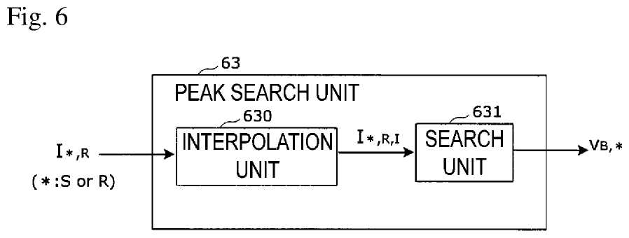

Thus, in the present embodiment, the peak search units 63R and 63S (in FIG. 6, the peak search units 63R and 63S are collectively referred to as “peak search unit 63”) include an interpolation unit (a first interpolation unit and a second interpolation unit) 630 and a search unit (a first acquisition unit and a second acquisition unit) 631. Furthermore, “*” included in the spectra I_{*, R} and I_{*, R, I}, and the frequencies ν_{B}, * illustrated in FIG. 6 is “R” in the case of the peak search unit 63R and “S” in the case of the peak search unit 63S.

The interpolation unit 630 interpolates the spectra I_{R, R} and I_{S, R} by using, for example, a zero padding method. In this case, the interpolation unit 630 performs the interpolation by adding a zero signal to the spectra I_{R, R} and I_{S, R}, and outputs the interpolated spectra I_{R, R, I} and I_{S, R, I}. The interpolation unit 630 may perform the interpolation processing entirely on each of the spectra I_{R, R} and I_{S, R}, or may perform the interpolation processing on only the spectrum within a certain range near the peaks of the spectra I_{R, R} and I_{S, R}. When the spectrum within a certain range near the peaks is interpolated, it is possible to reduce a calculation amount of the interpolation processing and an amount of memory used.

An example of a method of interpolating the spectrum within a certain range near the peak includes a method of performing peak search on the spectrum yet to be interpolated to identify a frequency ν′_{B}, * having a peak, and interpolating only a range of ν′_{B}, *−ν_{W} to ν′_{B}, *+ν_{W} of a predetermined frequency width ν_{W} over frequencies before and after the identified frequency ν′_{B*}. In another example, the data of the spectrum is discrete, and thus, the interpolation processing may be performed within a range of N_{PSF} around the peak. In this case, if N_{PSF} is an odd number, the interpolation processing will be performed in a range of ±(N_{PSF}−1)/2 around the peak. If N_{PSF} is an even number, the interpolation processing will be performed within a range of from pre-peak N_{PSF}/2 to post-peak N_{PSF}/2−1 or from pre-peak N_{PSF}/2−1 to post-peak N_{PSF}/2.

The search unit 631 acquires and outputs frequencies ν_{B, R} and ν_{B, S} at the peak positions of the interpolated spectra I_{R, R, I} and I_{S, R, I}.

The distance calculation unit 64 evaluates a half value z_{S} of the optical path length difference between the reference arm and the sample arm of the distance measurement interferometer 103, based on the frequency ν_{B, R} obtained by the peak search unit 63R, the frequency ν_{B, S} obtained by the peak search unit 63S, and a half value z_{R} of the optical path length difference between the reference arm and the sample arm of the interferometer 102 that is a reference interferometer, according to the following Equation (8).

$$\begin{matrix}Equation ( 8 ) & \\ {z}_{S} = {z}_{R} \cdot \frac{{ν}_{B , S}}{{ν}_{B , R}} & ( 8 )\end{matrix}$$

The half value z_{S} of the optical path length difference between the reference arm and the sample arm of the interferometer 103 evaluated according to the above Equation (8) represents a distance from the distance measurement interferometer 103 to the distance measurement target 104.

Here, a case is considered where a distance is measured by setting a position (reference position) of the distance measurement target at which a distance measurement result is 0 [m] to a position different from the position of the half value z_{S}=0 [m] of the optical path length difference. In this case, the distance calculation unit 64 may use the half value z_{S, 0} of the optical path length difference between the two arms of the distance measurement interferometer 103 measured in advance when the distance measurement result is 0 [m], to evaluate the distance measurement result from a value z_{S, C} obtained by correcting the half value z_{S} of the optical path length difference according to the following Equation (9).

Equation (9)

z_{S,c}=z_{S}−z_{S,0} (9)

### Hardware Configuration of Signal Processing Apparatus

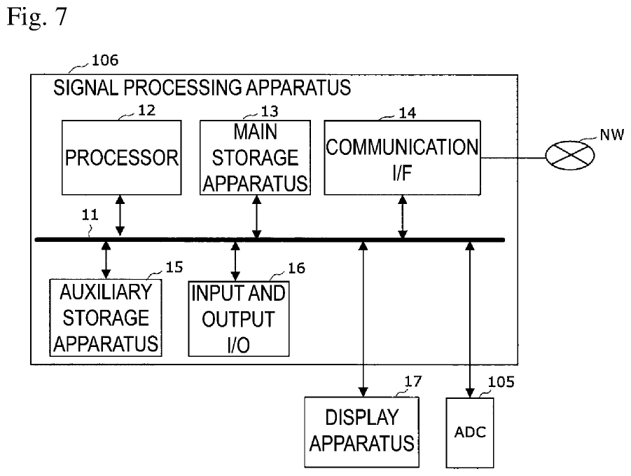

Next, an example of a hardware configuration of the signal processing apparatus 106 having the above-described function will be described with reference to a block diagram of FIG. 7.

As illustrated in FIG. 7, the signal processing apparatus 106 can be implemented, for example, by a computer including a processor 12, a main storage apparatus 13, a communication I/F 14, an auxiliary storage apparatus 15, and an input and output I/O 16 connected via a bus 11, and a program that controls these hardware resources. For example, the signal processing apparatus 106 may be connected with a display apparatus 17 via the bus 11 to display, on a display screen, a distance to the distance measurement target 104 from the distance measurement interferometer 103 evaluated by the distance calculation unit 64. Additionally, the ADC 105 and the like are connected via the bus 11 and the input and output I/O 16.

The main storage apparatus 13 is implemented by, for example, a semiconductor memory such as a SRAM, a DRAM, and a ROM. A program for causing the processor 12 to perform various controls or calculations is stored in the main storage apparatus 13 in advance. The provision of the processor 12 and the main storage apparatus 13 makes it possible to implement various functions of the signal processing apparatus 106 including the time data generation unit 60, the resampling units 61R and 61S, the spectrum calculation units 62R and 62S, the peak search units 63R and 63S, and the distance calculation unit 64 illustrated in FIG. 1. Furthermore, setting or control of the wavelength swept light source 100, the interferometers 102 and 103, the ADC 105, and the like can be performed by the processor 12 and the main storage apparatus 13.

The communication I/F 14 is an interface circuit for performing communication with various external electronic apparatuses via a communication network NW. The signal processing apparatus 106 may transmit the distance measurement result and the like to, for example, the outside via the communication I/F 14.

As the communication I/F 14, for example, an interface and an antenna compatible with wireless data communication standards such as LTE, 3G, 4G, 5G, wireless LAN, and Bluetooth (trade name) are used. The communication network NW includes, for example, wide area network (WAN), a local area network (LAN), the Internet, a dedicated line, a wireless base station, and a provider.

The auxiliary storage apparatus 15 is configured of a readable and writable storage medium, and a drive apparatus for reading or writing various types of information such as programs or data from or to the storage medium. A hard disk or a semiconductor memory such as a flash memory can be used as a storage medium in the auxiliary storage apparatus 15.

The auxiliary storage apparatus 15 includes a program storage area for storing a program for causing the signal processing apparatus 106 to perform a distance measurement processing including resampling time data generation processing, resampling processing, spectrum calculation processing, interpolation processing, peak search processing, and distance calculation processing. Further, the auxiliary storage apparatus 15 may have, for example, a backup area for backing up the data, programs, and the like described above.

Furthermore, the auxiliary storage apparatus 15 stores the half value z_{R} of the optical path length difference between the two arms of the interferometer 102 that is a reference interferometer and the half value z_{R} is used when the distance calculation unit 64 performs a distance calculation.

The input and output I/O 16 is configured of an I/O terminal for inputting a signal from an external apparatus such as the display apparatus 17 or outputting a signal to an external apparatus.

The signal processing apparatus 106 may be implemented by one computer or may be distributed by a plurality of computers connected to each other via the communication network NW. Further, the processor 12 may be implemented by hardware such as a field-programmable gate array (FPGA), a large scale integration (LSI), and an application specific integrated circuit (ASIC).

### Distance Measurement Method

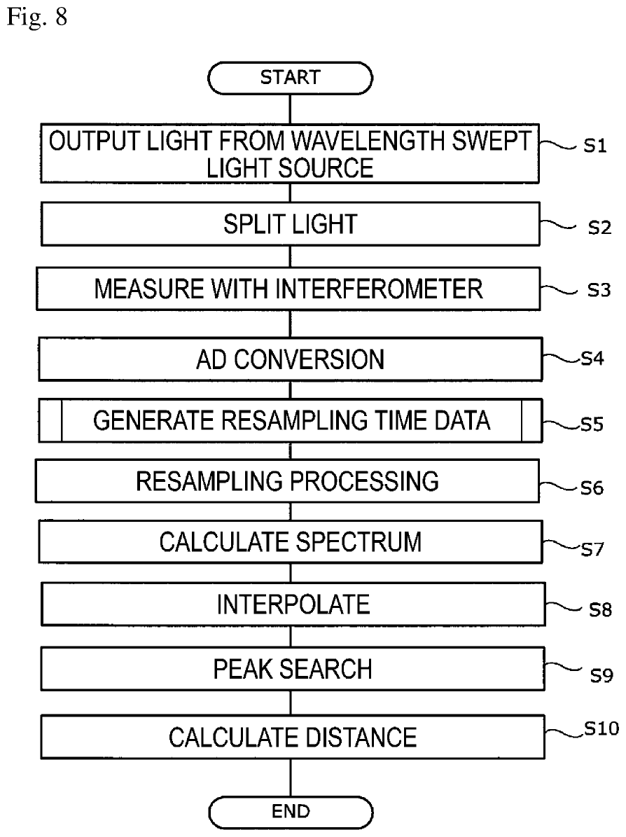

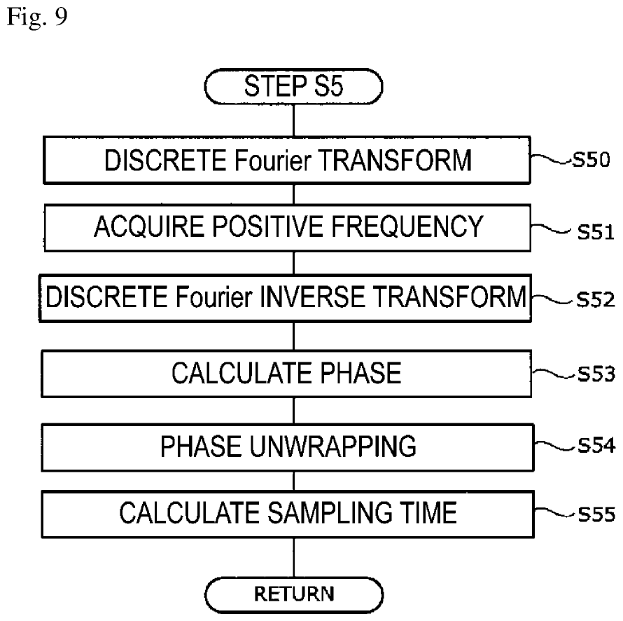

Next, the operation of the distance measurement apparatus 1 having a configuration described above will be described with reference to the flowcharts of FIGS. 8 and 9.

First, the wavelength swept light source 100 outputs wavelength-swept light continuously temporally changing in light frequency (step S1). Next, the coupler 101 splits the light output from the wavelength swept light source 100 into the reference optical path and the object optical path (step S2). Next, the light split by the coupler 101 is interfered and measured by the interferometers 102 and 103 (step S3). More specifically, the light split by the coupler 101 to the reference optical path passes through the reference arm and the sample arm in the interferometer 102 that is a reference interferometer, is detected as interference light, and is converted into an analog interference electrical signal.

On the other hand, the light split by the coupler 101 to the object optical path passes through the reference arm and the sample arm in the distance measurement interferometer 103, and is converted into an analog interference electrical signal detected as interference light.

Thereafter, the ADC 105 converts the analog interference electrical signal obtained by the interferometer 102 into a digital interference signal i_{R} at the CH1, and converts the analog interference electrical signal obtained by the distance measurement interferometer 103 into a digital interference signal is at the CH2 (step S4). More specifically, ADC 105 performs AD conversion in synchronization with a timing of a trigger signal TG output from the wavelength swept light source 100. The interference signals i_{R} and i_{S} output from the ADC 105 are input to the signal processing apparatus 106.

Next, the time data generation unit 60 generates, based on the interference signal i_{R} input from the CH1 and obtained from the interferometer 102 that is a reference interferometer, resampling time data tₙ(step S5).

Here, the resampling time data generation processing in step S5 will be described with reference to the flowchart of FIG. 9.

First, the discrete Fourier transform unit 601 applies discrete Fourier transform to the interference signal i_{R} and evaluates a frequency spectrum I_{R} indicating a spatial frequency component (step S50). Next, the frequency acquisition unit 602 acquires only the positive frequency component included in the frequency spectrum I_{R} (step S51). Next, the discrete Fourier inverse transform unit 603 applies the discrete Fourier inverse transform to the frequency spectrum including the positive frequency component I_{R}⁺ obtained in step S51 to restore the interference signal i_{R}⁺ in a spatial region (step S52).

Next, the phase calculation unit 604 calculates the argument arg (i_{R}⁺) of the interference signal i_{R}⁺ restored through the discrete Fourier inverse transform in step S52 to evaluate the phase θ_{R, wrap} (step S53). Next, the phase unwrapping unit 605 applies phase unwrapping to the phase θ_{R, wrap} in which a phase jump of 2π occurs, and outputs the phase-unwrapped argument θ_{R} as a phase change curve θ_{R} (step S54).

Next, the time calculation unit 610 divides the phase change curve θ_{R} to obtain evenly divided phases δθ and calculates, as the resampling time data tₙ, the time tₙ corresponding to each of the evenly divided phases δθ (step S55). Thereafter, the processing is returned to step S6 of FIG. 8.

Returning to FIG. 8, the resampling units 61R and 61S use the resampling time data to to resample the interference signal i_{R} obtained from the interferometer 102 that is a reference interferometer and the interference signal is obtained from the distance measurement interferometer 103 (step S6). More specifically, the resampling unit 61R resamples the interference signal i_{R} with the resampling time data tₙ providing equal phase intervals to rearrange the intensities of the interference signal i_{R} at regular intervals. Likewise, the resampling unit 61S resamples the interference signal i_{S} with the resampling time data tₙ. As a result, the frequencies of the resampled interference signals i_{R, R} and i_{S, R} take equal signal waveforms at anytime tₙ (graph (b) of FIG. 5).

Next, each of the spectrum calculation units 62R and 62S applies discrete Fourier transform to the resampled interference signals i_{R, R} and i_{S, R} to calculate the spectra I_{R, R} and I_{S, R} that are pieces of data with an intensity for each frequency representing as a real number (step S7). The spectra I_{R, R} and I_{S, R} calculated by the spectrum calculation units 62R and 62S represents the PSF corresponding to one reflection point from the distance measurement target 104 (mirror 25).

Next, the interpolation unit 630 included in each of the peak search units 63R and 63S performs the zero padding, for example, on the spectrum within a certain range near the peaks of spectra I_{R, R} and I_{S, R} for interpolation, and outputs the interpolated spectra I_{R, R, I} and I_{S, R, I} (step S8). The range of the spectra I_{R, R} and I_{S, R} to be interpolated by the interpolation unit 630 may be set to an optimum range according to a desired accuracy and amount of calculation.

Next, the search unit 631 included in each of the peak search units 63R and 63S acquires and outputs frequencies ν_{B, R} and ν_{B, S} at the peak positions of the interpolated spectra I_{R, R, I} and I_{S, R, I} (step S9).

Next, based on the frequencies ν_{B, R} and ν_{B, S} obtained in step S9, and the half value z_{R}, previously stored in the auxiliary storage apparatus 15, of the optical path length difference between the two arms of the interferometer 102 that is a reference interferometer, the distance calculation unit 64 evaluates the half value z_{S}, which represents the distance to the distance measurement target 104, of the optical path length difference between the two arms of the distance measurement interferometer 103 according to Equation (8) (step S10).

### Effect of Interpolation Processing

Here, an advantage that the interpolation unit 630 interpolates the spectrum within a certain range near the peaks of the spectra I_{R, R} and I_{S, R}, in the peak search units 63R and 63S according to the present embodiment, described in step S8 and FIG. 5, will be described in comparison with NPL1.

In the known example according to NPL 1, the zero padding is performed on the interference signals i_{R} and i_{S} to evaluate the power spectrum from the zero-padded interference signals. As such, in the known example, the processing of evaluating the power spectrum for the data amount of the sum of the total of each of the spectra I_{R, R} and I_{S, R} and the amount of data added for the zero padding is performed, and thus, requires the processing amount for the data obtained by adding the amount of zero data added by the zero padding to the original data amount.

In contrast, in the distance measurement apparatus 1 according to the present embodiment, the interpolation processing is performed after the spectra I_{R, R} and I_{S, R} that is the PSF is evaluated. In the present embodiment, it is possible to perform the interpolation processing with a minimum processing amount for only meaningful data not being buried in noise and being present only near the peaks of spectra I_{R, R} and I_{S, R}. In the distance measurement apparatus 1, the interpolation processing after evaluating the spectra I_{R, R} and I_{S, R} significantly effects a hardware design of the distance measurement apparatus 1, and thus, this is an important point.

The frequency ν_{B} of the interference signal i is expressed by the following Expression (10), where Δλ denotes a swept wavelength width, λ_{c} denotes a center wavelength, and f_{L} denotes a sweep frequency of the wavelength swept light source 100, and z denotes a distance to the distance measurement target 104.

$$\begin{matrix}Equation ( 10 ) & \\ {ν}_{B} = z \cdot {f}_{L} \frac{Δ λ}{{λ}_{c}^{2} - \frac{Δ {λ}^{2}}{4}} ≅ z \cdot {f}_{L} \frac{Δ λ}{{λ}_{c}^{2}} & ( 10 )\end{matrix}$$

Note that in the above Expression (10), it is assumed that a distance is measured with the interference signal i of half a cycle 1/(2f_{L}) of the wavelength swept light source 100, and that the frequency of the light source light changes linearly with respect to a time period. The approximate expression of the rightmost side of Expression (10) is an approximate expression where λc²>>Δλ²/4 is established.

In a typical example, when Δλ=0.5 [nm], λ_{c}=1.55 [μm], f_{L}=1 [kHz], and z=200 [m], the frequency ν_{B}=166 [MHz] of the interference signal i is obtained. For safety, a case is assumed where the sampling frequency fs is 500 [MHz], which is about three times the frequency ν_{B} of the interference signal i. In this case, an amount of data Nₛₐₘₚ obtained by sampling is Nₛₐₘₚ=ν_{B}/(2f_{L})=5×10⁸/(2×10³)=250,000.

In the present embodiment, the discrete Fourier transform is performed to calculate the spectra I_{R, R} and I_{S, R}, and thus, the calculated spectra I_{R, R} and I_{S, R} are discrete, but if the frequency width representing the frequency of the discrete spectra is δf, δf=2f_{L}=2 [kHz] is obtained. In the FMCW method or the SS-OCT method, as indicated in the above Expression (i), the distance z to the distance measurement target 104 and the frequency ν_{B} of the interference signal i are proportional to each other, and thus, when the distance corresponding to the frequency width δf is δz, the relationship of the following Equation (11) is established.

$$\begin{matrix}Equation ( 11 ) & \\ δ z \cdot \frac{{ν}_{B}}{δ f} = z & ( 11 )\end{matrix}$$

The substitution of Expression (10) and δf=2f_{L} into Equation (11) above and the rearrangement for δz yields the following Expression (12).

$$\begin{matrix}Equation ( 12 ) & \\ δ z = \frac{1}{2 Δ λ} ( {λ}_{c}^{2} - \frac{Δ {λ}^{2}}{4} ) ≅ \frac{{λ}_{c}^{2}}{2 Δ λ} & ( 12 )\end{matrix}$$

For example, in a case of Δλ=0.5 [nm] and λ_{c}=1.31 [μm], δz=1.72 [mm] is obtained. If the measurement requires μm accuracy, a distance resolution level needs to be less than 1 [μm], and thus, a distance resolution of approximately δz/10,000 is required. This value of “10,000” is referred to as “magnification A”. As a result, the final amount of data in this specific example is A·Nₛₐₘₚ=2,500,000,000.

In the present embodiment, in a case where the data is held in double precision floating point type, eight bytes are required for each data, and thus, the amount of data is 8·A·Nₛₐₘₚ=20,000,000,000 bytes (20 GB).

On the other hand, in the known example of NPL 1, in applying Fourier transform, complex numbers are used, and thus, the number of bytes with a capacity of twice the amount of data in the present embodiment is required. Moreover, in the known example, several times more buffer capacity than that is required for calculation operation. Thus, in the known example described in NPL 1, huge amounts of memory and calculation are required.

On the other hand, in the distance measurement apparatus 1 according to the present embodiment, in a case where after the spectra I_{R, R} and I_{S, R} representing the PSF are calculated, only the spectrum within a certain range near the peak is interpolated, if an adjustment such as narrowing the range to be interpolated is performed, it is possible to suppress the amount of memory and the amount of calculation.

For example, if a full width at half maximum of the wavelength sweep width δf is Δλ_{FWHM}, then the PSF, that is, PSF_{FWHM} which is the full width at half maximum of the spectra I_{R, R} and I_{S, R} is expressed by the following Expression (13).

$$\begin{matrix}Equation ( 13 ) & \\ {PSF}_{FWHM} = \frac{1}{2 Δ {λ}_{FWHM}} ( {λ}_{c}^{2} - \frac{{Δλ}_{FWHM}^{2}}{4} ) ≅ \frac{{λ}_{c}^{2}}{2 Δ {λ}_{FWHM}} & ( 13 )\end{matrix}$$

In the above Expression (13), for example, if Δλ_{FWHM}=0.25 [nm] and λ_{c}=1.31 [μm], full width at half maximum PSF_{FWHM}=3.44 [mm] is obtained. In actually calculating the PSF, a window function is applied to a “rescaled” interference signal i (for example, graph (b) of FIG. 5) having a changed scale of time period before the discrete Fourier transform. Thus, the full width at half maximum Δλ_{FWHM} of the wavelength sweep width δf substantially decreases by half, and full width at half maximum PSF_{FWHM} of the spectra I_{R, R} and I_{S, R}=about 6.88 [mm] is obtained. The PSF data amount N_{PSF} is N_{PSF}=PSF_{FWHM}/δz=6.88/1.72=4.

Assuming that the above-mentioned distance resolution of about δz/A (A=10,000) is required, the final amount of data is A·N_{PSF}=40,000. Furthermore, likewise, when the data is held in double precision floating point type, the amount of data is 8·A·N_{PSF}=320,000 bytes (420 KB). The ratio of the data amount R_{Data}, indicating [data amount in the present embodiment]/[data amount in the known example according to NPL 1], is expressed by the following Equation (14).

$$\begin{matrix}Equation ( 14 ) & \\ {R}_{Data} = \frac{8 \cdot A \cdot {N}_{PSF}}{8 \cdot A \cdot {N}_{samp}} = \frac{{N}_{PSF}}{{N}_{samp}} & ( 14 )\end{matrix}$$

In the example described above, the ratio of the data amount R_{Data} between the present embodiment and the known example of NPL 1 is approximately 4/250,000=1.6×10⁻¹⁵, and thus, in the present embodiment, it is possible to reduce the amount of data to be processed. Thus, in the distance measurement apparatus 1 according to the present embodiment, after the spectra I_{R, R} and I_{S, R} are evaluated, the spectra within a certain range near the peaks of the spectra I_{R, R} and I_{S, R} are interpolated, and thus, compared to the known example, the amount of data required to be processed is reduced incomparably, and the amount of calculation is also reduced incomparably.

### Effect of Distance Measurement Apparatus

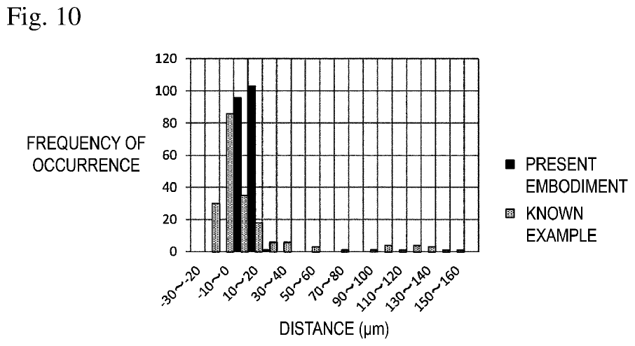

Next, an effect of the distance measurement apparatus 1 according to the present embodiment described above will be described with reference to FIG. 10. FIG. 10 is a histogram showing distance measurement results by the distance measurement apparatus 1 including the spectrum calculation units 62R and 62S and the peak search units 63R and 63S, and the known example according to NPL 1 for calculating the power spectrum, respectively. A vertical axis of FIG. 10 indicates a frequency of occurrence and a horizontal axis indicates a distance.

In FIG. 10, a scaling factor A=10,000 and a PSF data amount N_{PSF} was set to 201 to accommodate a margin. In addition, assuming Δλ=0.5 [nm] and λ_{c}=1.31 [μm] (δz=1.72 [mm]), distance measurement results are shown in units of 0.172 [μm]. Furthermore, the measurements were performed 200 times in each of the distance measurement apparatus 1 and the known example according to NPL 1, to acquire distance measurement results. In addition, in order that the distance measurement results obtained in the present embodiment and the known example can be easily compared, both the distance measurement results in the present embodiment and the distance measurement results in the known example indicate values obtained by subtracting the average value of the distance measurement results from the distance measurement results.

The distance measurement results shown in FIG. 10 resulted in the ratio of the data amount R_{Data}=N_{PSF}/Nₛₐₘₚ=201/250,000=8.04-4 between the present embodiment and the known example according to the above Equation (14) and the known example. It is shown that compared to the known example, the distance measurement apparatus 1 according to the present embodiment can achieve triple digit reduction in the amount of data. As a result, the distance measurement apparatus 1 can achieve an incomparable reduction in the amount of memory and data to be processed, compared to the known example.

Furthermore, the distance measurement apparatus 1 according to the present embodiment applies the discrete Fourier transform to the interference signals i_{R, R} and i_{S, R} and calculates the spectra I_{R, R} and I_{S, R} that are data with the intensity of each frequency as a real number. As a result, as compared to the distance measurement result obtained by using the power spectrum in the known example, as shown in FIG. 10, it can be seen that a distribution of the distance measurement results by the distance measurement apparatus 1 is narrower, and the distance measurement accuracy is improved as compared with the known example.

Furthermore, in the distance measurement apparatus 1 using the spectra I_{R, R} and I_{S, R}, a standard deviation was 3.84 [μm], but in the known example using the power spectrum, the standard deviation was 35.18 [μm]. It is indicated from this that the distance measurement apparatus 1 according to the present embodiment has a degree of accuracy of about nine times greater than the known example.

As described above, according to the present embodiment, in the distance measurement apparatus 1 using the FMCW method, in calculating the PSF, the spectrum with the intensity of the frequency component as a real number is used instead of the power spectrum, and thereafter, the spectrum that is the PSF is subjected to interpolation, and thus, it is possible to achieve a distance measurement apparatus being less susceptible to noise and having an excellent measurement accuracy.

### First Modification

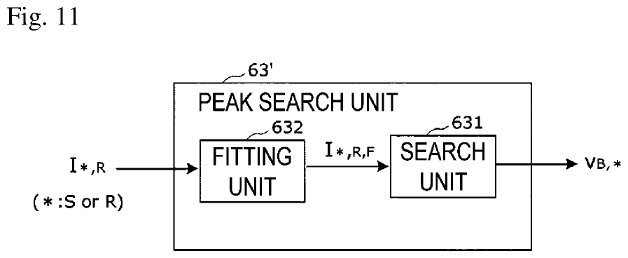

Next, the distance measurement apparatus 1 according to a first modification of the above-described embodiment will be described with reference to FIG. 11. The distance measurement apparatus 1 according to the first modification is configured in much the same way as the distance measurement apparatus 1 according to the present embodiment illustrated in FIG. 1. As illustrated in FIG. 11, the distance measurement apparatus 1 according to the first modification differs from the embodiment described above in that a peak search unit 63′ includes a fitting unit 632 instead of the interpolation unit 630.

The fitting unit 632 performs fitting on the spectra I_{R, R} and I_{S, R} of the interference signals i_{R, R} and i_{S, R} calculated by the spectrum calculation units 62R and 62S with a previously set function, and outputs the spectra I_{R, R, F} and I_{S, R, F} that are functions curve-fitted. For example, a Gaussian function, a quadratic function, and the like may be employed for the fitting function. In cases where it is known that the spectra I_{R, R} and I_{S, R} are a Gaussian function in theory, and can be accurately fit with the Gaussian function, when the intensities of the spectra I_{R, R} and I_{S, R} are converted with a logarithmic function and fit with a quadratic function, it is possible to improve the accuracy of fitting. In this case, the intensities of the spectra I_{R, R} and I_{S, R} can be converted into 10 log₁₀(I_{R, R}) and 10 log₁₀(I_{S, R}), for example.

The search unit 631 acquires frequencies ν_{B, R} and ν_{B, S} at the peak positions of the spectra I_{R, R, F} and I_{S, R, F} output from the fitting unit 632. For example, if the fitting is performed by employing a Gaussian function a·exp(b(ν−c)²) for the fitting function, the frequency at the peak position is c. When the quadratic function a·ν²+b·ν+c is used, the frequency at the peak position is −b/(2a). In this way, when the fitting is used, the peak search can be evaluated by using a parameter of the fitting function or through a simple calculation operation using the same, and thus, it is possible to reduce a calculation operation load.

As described above, in the distance measurement apparatus 1 according to the first modification, the peak search unit 63′ performs the fitting on the spectra I_{R, R} and I_{S, R} with a previously set function, and thus, it is possible to achieve a distance measurement apparatus being less susceptible to noise and having an excellent measurement accuracy.

Note that the embodiment described above provides an example of a configuration in which the interferometers 102 and 103 include the balanced detectors 24 and 34 where the interference light is detected and the detected light is converted into the interference electrical signal. However, instead of the balanced detectors 24 and 34, a photo detector having one input may be provided in each of the interferometers 102 and 103. In this case, one of two outputs split by the couplers 23 and 33 of the interferometers 102 and 103 is input to the photo detector.

Although exemplary embodiments of the distance measurement apparatus of the present disclosure have been described above, the present disclosure is not limited to the described embodiments, and various modifications that can be assumed by those skilled in the art can be made in the scope of the disclosure described in the claims.

### REFERENCE SIGNS LIST

1 . . . Distance measurement apparatus
100 . . . Wavelength swept light source
101, 20, 23, 30, 33 . . . Coupler
102, 103 . . . Interferometer
104 . . . Distance measurement target
21, 31 . . . Circulator
24, 34 . . . Balanced detector
25 . . . Mirror
105 . . . ADC
106 . . . Signal processing apparatus
60 . . . Time data generation unit
61R, 61S . . . Resampling unit
62R, 62S . . . Spectrum calculation unit
63, 63R, 63S . . . Peak search unit
64 . . . Distance calculation unit
600 . . . Curve calculation unit
610 . . . Time calculation unit
601 . . . Discrete Fourier transform unit
602 . . . Frequency acquisition unit
603 . . . Discrete Fourier inverse transform unit
604 . . . Phase calculation unit
605 . . . Phase unwrapping unit
630 . . . Interpolation unit
631 . . . Search unit
11 . . . Bus
12 . . . Processor
13 . . . Main storage apparatus
14 . . . Communication I/F
15 . . . Auxiliary storage apparatus
16 . . . Input and output I/O
17 . . . Display apparatus

1-8. (canceled)

9. A distance measurement apparatus comprising:
a first interferometer configured to detect first light obtained through interference between continuous light with a temporally swept wavelength, the continuous light being output from a light source, and reflected light obtained by reflecting the continuous light by a distance measurement target, and to convert the first light into a first interference electrical signal;
a first spectrum calculator configured to apply discrete Fourier transform to a digital first interference signal and to calculate a first spectrum of a discrete frequency component with an intensity of every frequency of the digital first interference signal as a real number, wherein the digital first interference signal is obtained by AD-converting the first interference electrical signal;
a first interpolator configured to interpolate a spectrum between frequencies of the first spectrum;
a first acquirer configured to acquire a first frequency of a peak included in the interpolated first spectrum; and
a distance calculator configured to calculate a distance to the distance measurement target based on the first frequency.

10. The distance measurement apparatus according to claim 9, further comprising:
a second interferometer configured to detect second light obtained through interference between the continuous light output from the light source and reflected light obtained by reflecting the continuous light by a mirror and to convert the second light into a second interference electrical signal;
a second spectrum calculator configured to apply discrete Fourier transform to a digital second interference signal and to calculate a second spectrum of a discrete frequency component with an intensity of every frequency of the digital second interference signal as a real number, wherein the digital second interference signal is obtained by AD-converting the second interference electrical signal;
a second interpolator configured to interpolate a spectrum between frequencies of the second spectrum; and
a second acquirer configured to acquire a second frequency of a peak included in the interpolated second spectrum.

11. The distance measurement apparatus according to claim 10, wherein the distance calculator is configured to calculate the distance to the distance measurement target based on the first frequency and the second frequency.

12. The distance measurement apparatus according to claim 11, wherein the first interpolator is configured to interpolate a spectrum within a previously set range including a peak of the first spectrum and the second interpolator is configured to interpolate a spectrum within a previously set range including a peak of the second spectrum.

13. The distance measurement apparatus according to claim 11, wherein the first interpolator is configured to fit a previously set function to the first spectrum and the second interpolator is configured to fit the previously set function to the second spectrum.

14. The distance measurement apparatus according to claim 11, further comprising:
a resampler configured to adjust a time scale of the digital first interference signal and the digital second interference signal to cause intensities of the digital first interference signal and the digital second interference signal to have a constant period with respect to a time period;
wherein the first spectrum calculator is configured to calculate the first spectrum based on the digital first interference signal with the time scale being adjusted by the resampler; and
wherein the second spectrum calculator is configured to calculate the second spectrum based on the digital second interference signal with the time scale being adjusted by the resampler.

15. The distance measurement apparatus according to claim 14, further comprising a time generator configured to generate a resampling time indicating the time scale used by the resampler from phase information of the digital second interference signal.

16. The distance measurement apparatus according to claim 11, wherein the distance calculator is configured to evaluate the distance to the distance measurement target from the first interferometer based on the first frequency, the second frequency, and a previously evaluated value indicating an optical path length difference between two optical paths of the second interferometer.

17. The distance measurement apparatus according to claim 11, wherein:
the first spectrum calculator is configured to apply a window function to the digital first interference signal and calculate the first spectrum based on the digital first interference signal applied with the window function; and
the second spectrum calculator is configured to apply a window function to the digital second interference signal and calculate the second spectrum based on the digital second interference signal applied with the window function.

18. A method of measuring a distance, the method comprising:
detecting first light obtained through interference between continuous light with a temporally swept wavelength, the continuous light being output from a light source, and reflected light obtained by reflecting the continuous light by a distance measurement target, and converting the first light into a first interference electrical signal;
applying discrete Fourier transform to a digital first interference signal and calculating a first spectrum of a discrete frequency component with an intensity of every frequency of the digital first interference signal as a real number, wherein the digital first interference signal is obtained by AD-converting the first interference electrical signal;
interpolating a spectrum between frequencies of the first spectrum;
acquiring a first frequency of a peak included in the interpolated first spectrum; and
calculating a distance to the distance measurement target based on the first frequency.

19. The method according to claim 18, further comprising:
detecting second light obtained through interference between the continuous light output from the light source and reflected light obtained by reflecting the continuous light by a mirror and converting the second light into a second interference electrical signal;
applying discrete Fourier transform to a digital second interference signal and calculating a second spectrum of a discrete frequency component with an intensity of every frequency of the digital second interference signal as a real number, wherein the digital second interference signal is obtained by AD-converting the second interference electrical signal;
interpolating a spectrum between frequencies of the second spectrum; and
acquiring a second frequency of a peak included in the interpolated second spectrum.

20. The method according to claim 19, wherein calculating the distance to the distance measurement target is based on the first frequency and the second frequency.

21. The method according to claim 20, further comprising:
interpolating a spectrum within a previously set range including a peak of the first spectrum; and
interpolating a spectrum within a previously set range including a peak of the second spectrum.

22. The method according to claim 20, further comprising fitting a previously set function to the first spectrum and fitting the previously set function to the second spectrum.

23. The method according to claim 20, further comprising:
adjusting a time scale of the digital first interference signal and the digital second interference signal to cause intensities of the digital first interference signal and the digital second interference signal to have a constant period with respect to a time period;
calculating the first spectrum based on the digital first interference signal with the time scale being adjusted; and
calculating the second spectrum based on the digital second interference signal with the time scale being adjusted.

24. The method according to claim 23, further comprising generating a resampling time indicating the time scale from phase information of the digital second interference signal.

25. The method according to claim 20, wherein evaluating the distance to the distance measurement target is based on the first frequency, the second frequency, and a previously evaluated value indicating an optical path length difference between two optical paths of an interferometer.

26. The method according to claim 20, further comprising:
applying a window function to the digital first interference signal and calculating the first spectrum based on the digital first interference signal applied with the window function; and
applying a window function to the digital second interference signal and calculating the second spectrum based on the digital second interference signal applied with the window function.
